(19) United States
(12) Patent Application Publication
(10) Pub. No.: US 2015/0376046 A1
(43) Pub. Date: Dec. 31, 2015

(54) METHOD FOR PRODUCING A GLASS WITH MIXING OF A MOLTEN GLASS STREAM AND DEVICE

(71) Applicant: SAINT-GOBAIN GLASS FRANCE, Courbevoie (FR)

(72) Inventors: Jean-Marc FLESSELLES, Fontenay sous Bois (FR); Emmanuelle GOUILLART, Bourg La Reine (FR); Marie JEFFROY, Paris (FR); Franck PIGEONNEAU, Epinay sur Orge (FR)

(21) Appl. No.: 14/768,553

(22) PCT Filed: Feb. 18, 2014
(86) PCT No.: PCT/FR2014/050341

§ 371 Date: Aug. 18, 2015

(30) Foreign Application Priority Data
Feb. 19, 2013 (FR) 1351407

(51) Int. Cl. C03B 5/187

(52) U.S. Cl. CPC C03B 5/187

(57) ABSTRACT

A method for producing a glass includes forming a horizontal stream of molten glass and mixing the stream. The mixing is created by rotatingly driving n shafts, n being a whole number equal to or greater than two, each having an axis, two adjacent shafts being separated by a distance with their axes parallel and with each of the two adjacent shafts connected to a rod located at least in part in the stream and each of the rods having an axis parallel to the axis of the shaft to which it is connected. For the two adjacent axes, the distance between the axis of one rod and the axis of the shaft to which it is connected is in excess of or equal to 9/20 of the distance between the axes of the two shafts. The two adjacent shafts are rotatingly driven in opposite directions with respect to one another.

The present invention is concerned with a method for producing a glass and more particularly with a stage for mixing the constituents of a stream of molten glass.

Such a mixing stage is generally carried out to homogenize the composition of a stream of molten glass over the entire section of said stream, prior to its shaping.

Such mixing can be realized, for example, when exiting from the furnace just before the molten glass stream is discharged onto a liquid bath (“float” method) for the production of flat glass.

Such mixing can also be realized, for example, just before the stream of molten glass is divided into small portions for the production of flasks or bottles.

Realizing mixing procedures by using mixing wells or cells is known.

International Patent Application No. WO 2004/078664 proposes utilizing a mixing cell which can be a shaping compartment which is approximately square or rectangular (when seen from above) and is provided with stirrers which are sufficiently high-performance to provide efficient homogenization. The dimension of said cell and the number of stirrers depend on the draw. Its operating temperature is generally between 1100° C. and 1350° C., notably around 1200° C.

U.S. Pat. No. 3,236,618 teaches a stirring device with horizontal paddles which displaces the glass both horizontally and vertically.

GB1229433 teaches a device for mixing molten glass with sand by means of two stirrers, the axes of which are aligned in the direction of the material stream. As a result of said configuration, there are large non-stirred zones on both sides of the stirrer, but they move very strongly closer to the walls so as to force the mixture to move into the stirred zone.

It is known to utilize a mixer which makes the glass circulate across a well where the stirring paddles are arranged, themselves being rotatingly driven, and which is placed between the outlet channel of the upstream furnace and the run-off lip which discharges the downstream stream of molten glass. Said solution gives very good results but it is very costly to produce and maintain and is very complex to implement and to utilize.

In the feeder systems and channels the stirrers can notably be vertical and comprise several levels of inclined paddles, with one stirrer in one direction and the other in the opposite direction so as to realize both vertical and horizontal mixing. Said stirrers are rotatingly driven together and can be realized, for example, in rhodium platinum, in refractory metal alloy or in structural ceramic (alumina, zirconium mullite, mullite, etc.).

The stirrers currently used industrially in the channels or feeders for producing glass only carry out partial mixing, which is often not sufficient to eradicate certain chemical faults in the glass in the stream downstream of the stirring. Said problem is very great for so-called “electronic” glass utilized in the electronic industry, notably for display screens, or even for photovoltaic panels.

The present invention intends to remedy the disadvantages of the prior art by proposing a method and a device which allow a stream of molten glass to be mixed in a manner that is simple, very efficient and is not expensive to implement, notably for implementation in the feeder systems and the channels.

The object of the invention is thus, in its widest sense, a method for producing a glass comprising the realization of a stream of molten glass which flows along a central axis and the mixing of said stream, said mixing being realized by rotatingly driving n shafts, n being a whole number equal to or in excess of two, each having an axis positioned at an angle of between 0° and 30° inclusive in relation to a vertical in the direction of the central axis of said stream, two adjacent shafts being separated by a distance D with their axes parallel and with each of said two adjacent shafts connected to at least one rod which is situated at least in part in said stream and each of said rods having an axis which is parallel to the axis of the shaft to which it is connected.

Moreover, for said two adjacent axes at least, the distance between at least one rod and the shaft to which it is connected is in excess of or equal to 9/20 of the distance between said two shafts, and said two adjacent shafts are rotatingly driven in opposite directions with respect to one another with, following the direction of the stream and considering, when seen from above, that one of said two adjacent shafts is on the left and the other is on the right, the left-hand shaft being driven in the anticlockwise direction and the right-hand shaft being driven in the clockwise direction.

Thus, as a result of choosing the opposite direction of rotation, the effect of the rotation of the rods is to increase the speed of the stream in an overlap zone which is situated between said two shafts.

For two adjacent shafts at least, the distance between at least one rod and the shaft to which it is connected, is, in a preferred manner, in excess of or equal to half the distance between the axes of said two shafts, or is even in excess of the half the distance between the axes of said two shafts so as to improve the efficiency of the mixing.

The principle of the invention is thus based on the use of several rods which draw the fluid sufficiently such that residual inhomogeneities are reduced by molecular diffusion. So-called “chaotic” mixers realize said process efficiently, and even, in a certain sense, optimally. The connection to the chaos theory resides in the intersection between the trajectories of fluid particles which results in exponential draw in terms of time. Said theory supplies elements to quantify the efficiency and the quality of the mixing.

So that the rods which are immersed into the molten glass realize chaotic mixing, it is necessary in particular for the trajectories of the rods to intersect so that the fluid filaments can be drawn successively by the different rods but equally folded back. This is essential in order to obtain the multiplicative effect which thus makes the mixing more efficient.

So that the rods catch and draw all the fluid elements, and therefore homogenize the fluid correctly in fine, the speed of rotation has to be adapted to the flow; the more the flow of the stream of molten glass is increased, the more the speed of rotation of the rods must be increased.

In a first embodiment variant of the method according to the invention, for said two adjacent shafts, one of said shafts is connected to at least one rod which is situated at least in part in said stream and the other shaft is connected at least to two rods which are each situated at least in part in said stream.

In a sub-variant of said first variant, for said two adjacent shafts, one of said shafts is connected to at least two rods which are situated at least in part in said stream and the other shaft is connected at least to two rods which are each situated at least in part in said stream.

In a second embodiment variant of the method according to the invention, which is independent of the first one, four adjacent shafts are rotatingly driven and each of said shafts is connected to a single rod, two adjacent shafts being rotatingly driven in opposite directions with respect to one another, following the direction of the stream and considering, when seen from above, that one of said two adjacent shafts is on the left and that the other one is on the right, the left-hand shaft is driven in the anticlockwise direction and the right-hand shaft is driven in the clockwise direction.

In particular, it is preferable that said two adjacent shafts, which are rotatingly driven in opposite directions with respect to one another, are rotatingly driven at the same speed during mixing with an initial dephasing which is
either 0° with two shafts each comprising one single rod,
or 180°/x in relation to the adjacent shaft, x being the number (integral number) of rods of the shaft to which the largest number of rods amongst the two adjacent shafts considered is connected and x≧2.

Obviously, the rotations of the rods (trajectory and direction) are such that there is never any impact between two rods when the invention is implemented as such an impact, repeated, would generate premature wear of the rods concerned.

In a preferred manner, the axes of said two adjacent shafts which are rotatingly driven in opposite directions with respect to one another are situated in a plane which is perpendicular to the direction of the central axis of the stream.

In a preferred manner furthermore, said two adjacent shafts, which are rotatingly driven in opposite directions with respect to one another, are arranged at an equal distance from the central longitudinal axis of the stream so as to improve further the mixing and in particular the homogeneity transversally with respect to said stream.

In a preferred manner furthermore, in order to optimize the efficiency of the mixing, the speed of rotation of the shafts is between 1 and 20 revolutions per minute inclusive of said values for a stream speed upstream of the mixing of between 0.1 and 5.0 mm/s inclusive of said values.

The stream has a draw number nb which is at least equal to 20 and in particular is in excess of or equal to 35 (and notably is less than or equal to 1000), said draw number nb being=L/(UT), with:
L which is a length along the axis of the stream along which the mixing is carried out, in mm,
U which is the mean speed of the fluid along said length, in mm/s, and
T which is the period of rotation of said shafts which are rotatingly driven in opposite directions with respect to one another and which is worth 60/V where V is the speed of rotation of said shafts in revolutions/minute.

In one variant, the distance between the rods and the shaft to which said rods are connected is identical during the mixing so as to preserve simplicity of operation.

In another variant, at least one shaft and in a preferred manner all the shafts, dip(s) into the said stream, in a preferred manner said shaft or said shafts which dips or dip into said stream have in the part thereof which dips into said stream a form which is asymmetric in relation to the axis of the shaft, and in a further preferred manner at least one screw or at least one paddle which turns in said stream in order to reduce the “dead zone” effect, with weak mixing, perpendicular to the shafts.

The present invention also concerns a device for producing a glass, notably for implementing the method according to the invention, comprising a furnace which generates a stream of molten glass and an stirrer to mix said stream, said device comprising n shafts which are rotatingly driven, n being a whole number equal to or in excess of two, each having an axis positioned at an angle of between 0° and 30° inclusive in relation to a vertical in the direction of the central axis of said stream, two adjacent shafts being separated by a distance D with their axes parallel and with each of said two adjacent shafts which is connected to at least one rod which is situated at least in part in said stream and each of said rods having an axis which is parallel to the axis of the shaft to which it is connected, for said two adjacent axes at least, the distance between the axis of one rod and the shaft to which it is connected is in excess of or equal to 9/20 of the distance between said two axes, and said two adjacent shafts are rotatingly driven in opposite directions with respect to one another with, following the direction of stream and considering, when seen from above, that one of said two adjacent shafts is on the left and the other is on the right, the left-hand shaft being driven in the anticlockwise direction and the right-hand shaft being driven in the clockwise direction.

In a first embodiment variant of the device according to the invention, for said two adjacent shafts, one of said shafts is connected to at least one rod which is situated at least in part in said stream and the other shaft is connected to at least two rods which are each situated at least in part in said stream.

In a sub-variant of said first variant, for said two adjacent shafts, one of said shafts is connected to at least two rods which are situated at least in part in said stream and the other shaft is connected to at least two rods which are each situated at least in part in said stream.

In a second embodiment variant of the method according to the invention, which is independent of the first one, four adjacent shafts are rotatingly driven and each of said shafts is connected to a single rod, two adjacent shafts being rotatingly driven in opposite directions with respect to one another with, following the direction of the stream and considering, when seen from above, that one of said two adjacent shafts is on the left and that the other one is on the right, the left-hand shaft being driven in the anticlockwise direction and the right-hand shaft being driven in the clockwise direction.

In a preferred manner also for said device, for said two adjacent shafts at least, the distance between the axis of one rod and the shaft to which it is connected is in excess of or equal to half the distance between the axes of said two shafts, or is even in excess of half of the distance between the axes of said two shafts.

In a preferred manner moreover, two adjacent shafts which are rotatingly driven in opposite directions with respect to one another are arranged at an equal distance from the central longitudinal axis of the stream so as to improve further the mixing.

In one specific variant, at least one rod, and in a preferred manner each rod, has a smooth surface, without any additional mechanical means for mixing. This means that the rod does not have a particular screw-type profile or does not have horizontal paddles. The rod therefore is in the form of a cylinder, the transversal section of which is constant, in a preferred manner said section being of the circular type but not necessarily circular. In a surprising manner, it has been noted that it was possible to provide additional mechanical mixing means on the surface of the rods which dip into the stream, but that this hardly improves the very good mixing already obtained with the smooth surface rods; now, such smooth rods are easier to produce and are less expensive; they are, moreover, less fragile and their wear is more uniform, therefore easier to control.

In one quite specific variant, at least one rod, and in a preferred manner each rod, has a circular section which, in a preferred manner, is identical all along the rod, with a preferred diameter of between 20 and 150 mm inclusive, or even of between 40 and 100 mm inclusive. The rods can be realized, for example, in rhodium platinum, refractory metal alloy or in structural ceramic (alumina, mullite zirconium, mullite, etc.).

The performance of the mixer according to the invention is much better than that of the stirrers of the prior art and said performance is hardly sensitive to the conditions of use. In fact, rods which are displaced in agreement with the invention allow a larger volume of fluid to be “driven” and are able to draw more than screws or paddles where the range of action is a lot weaker and they therefore allow a larger quantity of badly mixed fluid to pass. The mixing according to the invention is thus much more homogeneous for the fluid as a whole.

The device according to the invention, if applicable, allows for mixing solely within horizontal planes which do not mix together (if one wants to avoid, for example, contaminating the glass with glass close to the sole which is richer in refractory material). This is bi-dimensional mixing which is particularly not very energy-intensive. The glass is thus moved essentially horizontally and without any vertical component as a result of stirring according to the invention. Said type of stirring frees the stirrer from all vertical lift. The stirrer therefore has little to do in a mechanical plane and for this reason can be realized in a material that is relatively less resistant than others but is more refractory, like a ceramic material. Said bi-dimensional stirring up of the glass is brought about by the vertical rods, notably of the cylindrical type. The existence of at least one horizontal bar which connects different rods which are actuated by the same shaft is not ruled out. Said bar serves essentially to reinforce the solidity of the stirrer and in a preferred manner does not exert any vertical lift and can therefore also be essentially cylindrical. This is therefore a device which is high-performance, not Very expensive, sturdy and flexible. Such a device is extremely high-performance when it is a question of homogenizing a glass before it its formed into flat glass. In fact, bi-dimensional mixing which forms horizontal strata is largely sufficient for flat glass since possible different composition strata are found parallel to the formed glazing and are not caused by any optical distortion.

The imposition of a tri-dimensional component on the flow would be obtained by arranging inclined paddles, for example, on the surface of the rods, which would therefore realize mixing in three dimensions in space. However, such an embodiment is much more energy-intensive, demands much more from the materials and does not generally seem necessary. Nevertheless, a certain vertical mixing component is authorized according to the invention. The proportion of horizontal mixing and of vertical mixing can be determined by comparing the mean draw rates between the exit and the entry of the device according to the invention. In order to measure said mean draw rates, numeric simulation is effected in the manner known to the expert. The draw rate corresponds to the distance between two fluid particles when exiting the device in relation to the initial extremely close distance between them at the entrance of the device. Said vertical minority mixing component can be provided by elements traditionally implemented for mixing viscous fluids, like paddles or helical corrugations, etc.

Notably, according to the invention, the mixing of the stream is realized preferentially in horizontal planes, the mean draw rate in the horizontal plane being at least 10 times and in a preferred manner at least 30 times and in a manner preferred even more at least 50 times in excess of the mean vertical draw rate.

In the absence of a vertical mixing component, the mixing of the stream is realized solely within horizontal planes which do not mix together.

Finally, when the color of the glass is obtained by “coloration in the feeder” (in the bottle-making industry for example), the mixers according to the invention allow much better homogeneity of color to be obtained than the screw stirrers currently used.

The present invention will be better understood by reading the detailed description below of non-limiting exemplary embodiments and of the accompanying figures:

FIG. 1 shows a horizontal sectional view, when seen from above, of an exemplary embodiment of a stirrer according to a first variant of the invention with two shafts and four rods, as well as the trajectories of the rods;

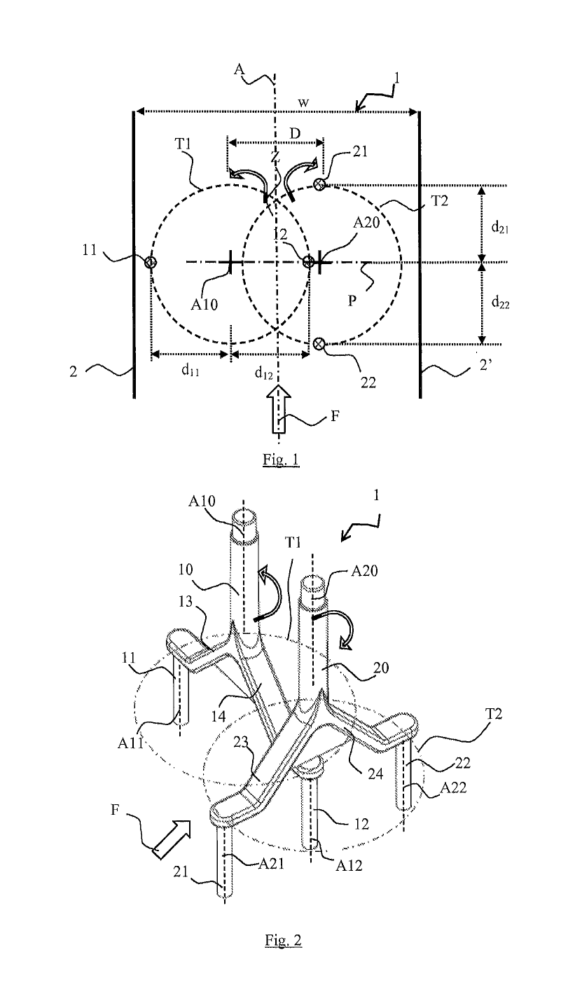

FIG. 2 shows a perspective view of an exemplary embodiment of a stirrer according to FIG. 1;

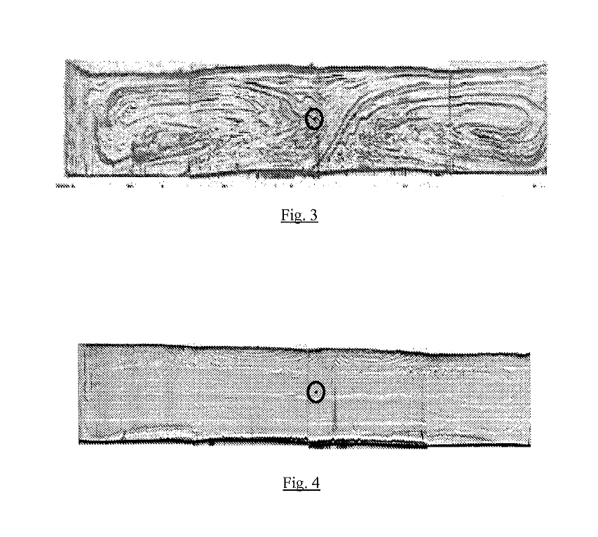

FIG. 3 shows a strioscopic image without stirring;

FIG. 4 shows a strioscopic image of the stirring realized using an stirrer according to FIG. 1;

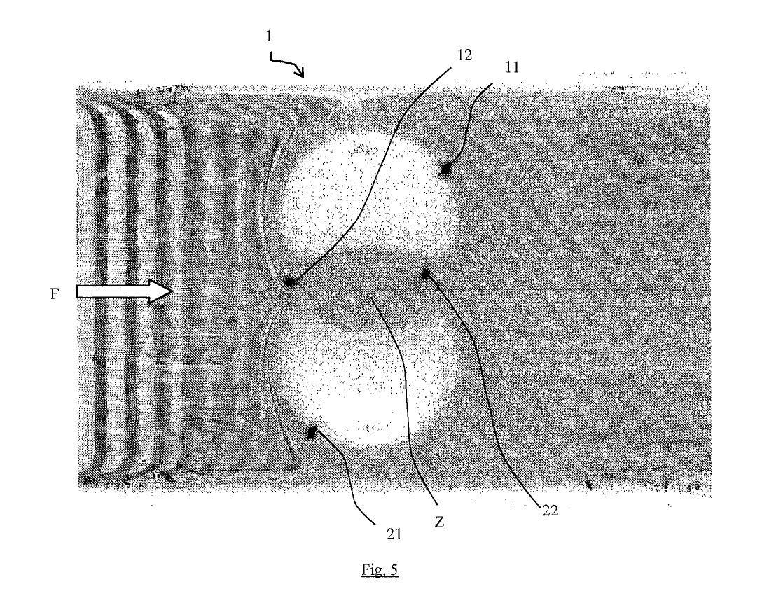

FIG. 5 shows a simulation of the effects of stirring realized using a stirrer according to FIG. 1;

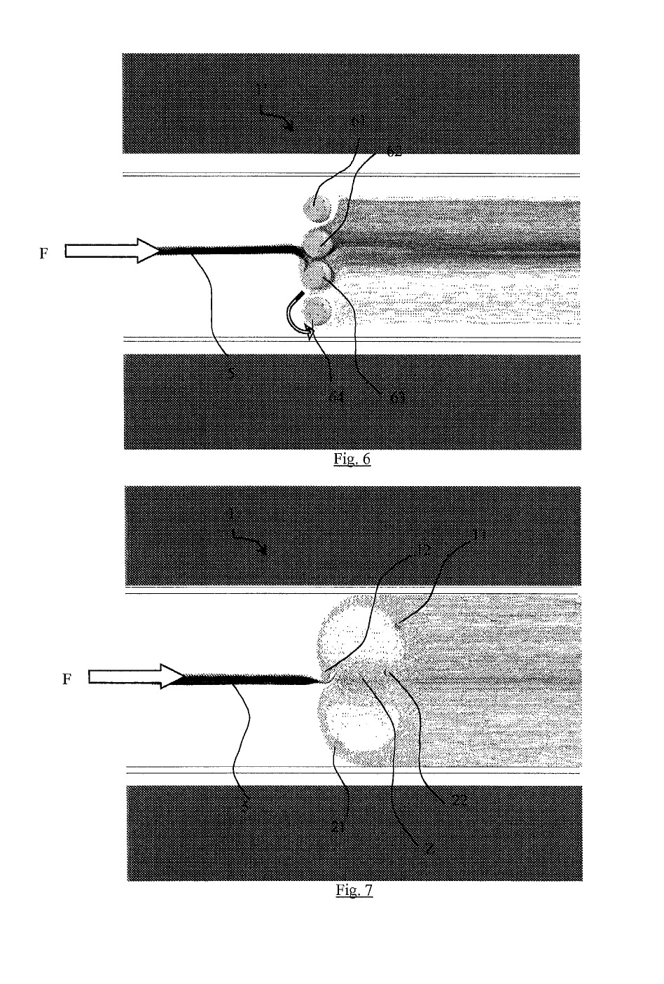

FIGS. 6 and 7 show a compared simulation, when seen from above, of two stirrers under the same conditions, respectively for a stirrer with four screws aligned vertically and for a stirrer according to FIGS. 1 and 2; and

FIG. 8 shows a horizontal sectional view, when seen from above, of an exemplary embodiment of a stirrer according to a second variant of the invention with four shafts and four rods, as well as the trajectories of the rods.

For all said figures, the proportions between the different elements are respected to make it easier to read.

The present invention relates to a method and to a device for producing a glass, and more precisely to the mixing of the different constituents of the glass in the molten state.

Such a method and such a device utilize a furnace which generates a stream of molten glass which is approximately horizontal in practice and which is shown by the thick arrow F at the bottom of FIG. 1.

To be mixed, said stream traverses a stirrer 1 from bottom to top in FIG. 1; in practice, as the stream is horizontal, it traverses the stirrer from left to right or from right to left. Said stirrer is shown in perspective in FIG. 2.

According to the invention, it is provided that the rods 11, 12, 21, 22, in this case four in number, dip vertically into the stream so as to mix it.

The rods 11, 12; 21, 22 are connected respectively in twos to one shaft 10, 20 (not shown in FIG. 1), in this case two in number. Said two shafts are separated by a distance equal to D which is measured perpendicular to the stream. Each shaft is rotatingly driven; only the vertical axes A10 and A20 of said two shafts can be seen in FIG. 1. Said shafts 10, 20, which are adjacent, are arranged at an equal distance, D/2, from the central longitudinal axis of the stream F.

The vertical axes A11, A12, A21, A22, of rods 11, 12, 21, respectively, are displaced in relation to the axes A10, A20: the axes A11, A12 are situated respectively at a distance d₁₁, d₁₂ from the axis A10 and the axes A21, A22 are situated respectively at a distance d₂₁, d₂₂ from the axis A20.

Said distances are identical: arms 13, 14; 23, 24 connect the rods 11, 12; 21, 22 respectively to the shafts 10; 20.

In this case, the shafts and the arms are not in the stream F; only the rods are in the stream F.

As can be seen in FIG. 1 for the two shafts, the distance d₁₁, d₁₂; d₂₁, d₂₂ between at least one rod and the shaft to which it is connected is in excess of or equal to 9/20 of the distance D between said two shafts. Said distance can be in excess of or equal to half the distance D between the axes of said two shafts, or even in excess of half the distance D between the axes of said two shafts.

T1 and T2 show the trajectories of the axes of the rods of the shaft 10 and 20 respectively.

As can also be seen in FIG. 1, the two adjacent shafts 10, 20 are rotatingly driven in opposite directions with respect to one another. When seen from above, following the direction of the stream and considering that one of said two adjacent shafts is on the left and that the other is on the right, the left-hand shaft is driven in the anticlockwise direction and the right-hand shaft is driven in the clockwise direction. Said two shafts are rotatingly driven in opposite directions with respect to one another in order to increase the speed of the stream in a trajectory overlap zone Z which is situated between said two shafts. Said two adjacent shafts 10, 20 are arranged symmetrically in this case in relation to the central axis A of said stream F, at an equal distance from said axis.

FIG. 1 shows that by following the direction of the stream (in this case from the bottom to the top of the page) and that by considering that said stream is seen from above, one shaft, the shaft 10, is situated on the left and that the other shaft, the shaft 20, is situated on the right, therefore the left-hand shaft 10 is rotatingly driven in the anticlockwise direction in relation to its axis A10 and the right-hand shaft 20 is driven in the clockwise direction (direction of the hands of a watch) in relation to its axis A20.

In the configuration shown in FIGS. 1 and 2, the two shafts are both situated on a straight line P perpendicular to the direction of the stream F to be mixed and are both rotatingly driven at the same speed during mixing with an initial dephasing of 180°/2 (that is to say 90°) with respect to one another.

It is possible to generalize said arrangement by providing that the n shafts are all rotatingly driven at the same speed during mixing with an initial dephasing during mixing which is
either 0° with two shafts each comprising one single rod,
or 180°/x in relation to the adjacent shaft, x being the number of rods for the shaft to which the largest number of rods is connected.

Furthermore, in said configuration shown, each rod has a circular section which is identical all along the rod, with a preferred diameter of between 20 and 150 mm inclusive, or even of between 40 and 100 mm inclusive.

By way of example, a stirrer 1 has been realized with:
the distance d₁₁, d₁₂; d₂₁, d₂₂, between the axis A11, A12, A21, A22 of each rod, 11, 12, 21, 22 respectively, and the axis A10, A20 of the shaft 10, 20 to which it is connected, of 310 mm
the distance D between the axes of the two shafts 10, 20, of 350 mm
the diameter of each rod 11, 12, 21, 22 of 40 mm over the entire height of the rod situated in the stream F
a height of stream F of 300 mm
a width w of stream F between the walls on the left 2 and the right 2′ of the stirrer of 1100 mm.

It is thus observed that for the two adjacent shafts, the distance d₁₁, d₁₂; d₂₁, d₂₂ between each rod and the shaft to which it is connected is in excess of the distance D between said two shafts. The ratio between said distances d₁₁, d₁₂; d₂₁, d₂₂ and the distance D, d/D=310/350=0.88 (with d=d₁₁, d₁₂, d₂₁ or d₂₂).

It is recommended that the ratio d/D is in excess of ¾ so as to obtain an overlap zone Z of the two trajectories T1, T2 which is sufficient to obtain the desired efficiency.

The rods must not be in contact with the sole; a minimum distance of between 20 and 60 mm must be provided between the bottom of each rod and the sole.

In said example, by applying the formula nb=L/(UT), where
L the length along the axis of the stream along which the mixing is carried out is equal to the distance between two rods ((d₁₁+d₁₂=620 mm) increased by the sum of half the diameter of the two rods (40/2+40/2), L=660 mm
U, the mean speed of the fluid along said length, is 2 mm/s, and
T the period of rotation of said shafts (10, 20) rotatingly driven in opposite directions with respect to one another, is worth 60/V where V the speed of rotation of said shafts is 8 revolutions/minute, the stream, therefore, has a draw number nb=660/(2×(60/8))=44.

Said draw number is well in excess of 20 and is even in excess of 35.

FIGS. 3 and 4 each show a numeric strioscopic image.

The principle of the strioscopic image is based on observing in transmission the deviation of a collimated light beam (parallel light beam) during the passage across a specimen of glass: this is a “shadow” method. In fact, local variations in the refraction index act as elementary lenses which are going to make the light beam converge or diverge (light beams curve in the direction of the index gradients), which lead to illumination inhomogeneities exiting from the specimen. The image obtained in transmission is displayed on a CCD camera. The image obtained is called a strioscopic image (striogram). The zones where the refraction index is locally weaker than the surrounding environment will act as diverging lenses (dark zones of the stratification on the strioscopic image) and the zones with the stronger local index will act as converging lenses (bright zones of the stratification on the strioscopic image).

The direction of flow of the molten glass is indicated by the point surrounded by a circle. The top face of the stream in relation to the vertical is the face situated on top in each figure.

FIG. 3 shows a strioscopic image obtained without any stirring whatsoever, when there is no stage for mixing the stream of glass and no device for mixing across the stream. The streaks are wide, numerous and oriented in very varied directions.

FIG. 4 shows the strioscopic image obtained during the implementation of the solution of FIGS. 1 and 2 with the parameters indicated previously. The streaks are fine, not very numerous and oriented essentially parallel to the top face of the stream, which limits their harmful effect. In said FIG. 4, the homogeneity of the glass is very good, almost perfect.

The trajectories of 48,000 massless fluid particles have been calculated using a tracing algorithm.

FIG. 5 shows a numeric simulation of the above-provided effects of the stirrer on the stream F for a speed of rotation of the shafts 10, 20 (not visible in FIG. 5) of 8 revolutions per minute. More precisely, FIG. 5 superimposes the position of the fluid particles between their position at the start of a period of rotation of the stirrer and the position at the end of a period of rotation of the stirrer (that is to say a complete rotational revolution of the two shafts; all periods are not shown).

The black streaks upstream of the stirrer 1 show the arrival of an inhomogeneous stream upstream of the stirrer.

It is possible to observe that downstream of the stirrer 1, there are no more streaks at all; the glass stream is completely mixed thanks to the rod trajectory overlap zone Z.

It has been observed that, within the range of between 1 and 20 revolutions per minute, markedly increasing the speed of rotation can sometimes allow the quality of the mixing to be increased.

It has been observed that, within the diameter range of the rods from 20 to 150 mm, increasing the diameter can sometimes allow the quality of the mixing to be increased. Better results have been obtained with rods that all have a diameter of between 4 and 100 mm inclusive.

It has been observed that the mixing is homogeneous in all horizontal planes of the stream when, at least one rod 11, 12; 21, 22, and in a preferred manner each rod, has a smooth surface, as can be seen in FIG. 2, without any additional mechanical mixing means on its surface.

The cost of the mixer shown in FIGS. 1 and 2 is less than that of stirrers used in the prior art and said mixer is relatively easy to install, only requiring two axes of rotation (and therefore just two holes in the dome).

With said configuration, it is possible to mix a stream of molten glass in a manner that is simple, very efficient and not very costly to implement.

The rotating/counter-rotating movement of the rods has the effect of bringing the elements of the stream toward the center of the stream in the upstream part of the plane P and has the effect of pushing the elements of the stream toward the side walls in the downstream part of the plane P: said double effect is essential to allow for homogenization along the width of the fluid.

However, in terms of the quantity of the elements added into the stream upstream of the mixer, in order to obtain homogeneous mixing downstream of the mixer, it can be necessary to provide additional mechanical means, such as, for example, paddles.

FIGS. 6 and 7 each show a simulation of the effect on a stream of material 5 introduced in the center of the stream F, respectively upstream:
of a stirrer 1′ which comprises four vertical screws 61, 62, 63, 64, left-hand thread, aligned in a plane perpendicular to a horizontal stream F and rotatingly driven in the same direction, in FIG. 6 in the anticlockwise direction when seen from above,
of a stirrer of FIGS. 1 and 2 with the parameters indicated previously for a horizontal stream F.

FIG. 7 shows a better distribution of the stream of material downstream of the stirrer 1 of FIG. 5 than downstream of the stirrer 1′ of FIG. 6.

In the configuration illustrated in FIGS. 1 and 2, the stirrer thus comprises n=2 shafts each having a vertically positioned axis, with x=2 rods each having a vertically positioned axis which are connected to each shaft and each of which dip into the stream F which flows along a central horizontal axis A. The axes of the shafts are therefore positioned at an angle of 90° in relation to the direction of the central axis A.

All the shafts are positioned with their axes parallel to one another.

However, it is possible for the direction of the central axis A not to be horizontal but to be inclined in relation to the horizontal, notably in order to promote the flow of the stream. In said case, the axes of the shafts can be perpendicular to the central axis, or can be vertical, or can be inclined by an angle of between 60° and at least 90° inclusive in relation to the direction of the central axis A.

Whether or not the direction of the central axis A is horizontal, it is possible for the shafts to be positioned such that they each have an axis positioned at an angle of between 60° and at least 90° inclusive in relation to the direction of the central axis A of said stream F, that is to say that the shafts each have an axis positioned at an angle of between 0° and 30° inclusive in relation to a vertical in the direction of the central axis A of said stream F so as to add an additional component into the mixing and to increase further the possibilities for homogenization. The “vertical” considered here is a relative vertical; it is considered in relation to the direction of the central axis A of said stream F. In other words, it is perpendicular to the direction of the central axis A of the stream F and is included in the vertical plane which comprises the direction of the central axis A of the stream F.

In terms of the width of the stream F, it is possible to provide n=3 shafts, or even n=4 shafts, or even more again, always with:
a shaft connected to at least one rod which dips into the stream F
a shaft connected to at least two rods which dip into the stream F, and
each rod having an axis parallel to the axis of the shaft to which it is connected.

An even number of shafts is preferred; however, an uneven shaft number can be advocated notably when the stream upstream of the mixer has a dissymmetry in relation to the central axis A.

In the case where three shafts (n=3), or even more, are used, it is preferable so that the mixing is as homogeneous as possible for the two adjacent shafts, at least even for all the adjacent shafts, the distance between the axis of one rod and the axis of the shaft to which it is connected is in excess of or equal to 9/20 of the distance between the axes of said two adjacent shafts. Said distance can be in excess of or equal to half the distance D between the axes of said two shafts, or can even be in excess of half of the distance D between the axes of said two shafts.

In the case where three shafts (n=3), or even more, are used, it is preferable so that the mixing is as homogeneous as possible for
on the one hand, two adjacent shafts to be rotatingly driven in opposite directions with respect to one another with, following the direction of the stream and considering, when seen from above, that one of said two adjacent shafts is on the left and the other is on the right, the left-hand shaft being driven in the anticlockwise manner and the right-hand shaft being driven in the clockwise manner and
on the other hand, for each other shaft next to one of said two adjacent shafts (other shaft the trajectory of the rod or rods of which intersect a trajectory of a rod of one of the two adjacent shafts) said other shaft to be driven in the same direction of rotation as the adjacent shaft, one rod at least of which intersects the trajectory of its own rod or rods.

In the case where three shafts (n=3), or even more, are used, it is preferable so that the mixing is as homogeneous as possible according to the direction of the stream for all the shafts to be situated on a straight line P perpendicular to the central axis A of the stream F to be mixed and for them all to be rotatingly driven at the same speed during mixing with an initial dephasing of 180°/x (that is to say 180°) in relation to the adjacent shaft if there is only one adjacent shaft or in relation to the two adjacent shafts if there are two of them.

In the case where two adjacent shafts each include one single rod, then said two shafts are rotatingly driven at the same speed during mixing with zero initial dephasing with respect to one another.

In the case where an exceedingly high-performance stirring is necessary, it is possible to arrange two rows (straight line P), or even more, of shafts in order to obtain a multiplicative draw effect of the elements in the stream.

FIG. 8 shows a second embodiment variant of the invention for which four adjacent shafts 10, 20, 30, 40 (not visible in said figures, only the axes A10, A20, A30, A40 respectively of said shafts are shown) are rotatingly driven and each of said shafts is connected to one single rod 11, 21, 31, 41, two adjacent shafts 10, 20 being rotatingly driven in opposite directions with respect to one another.

In said variant, the elements common to the preceding variant are referenced in the same manner.

T1, T2, T3 and T4 show the trajectories of the axes of the rods of the shafts 10, 20, 30 and 40 respectively, drawn as a dotted line.

The two adjacent shafts 10, 20 which are rotatingly driven in opposite directions with respect to one another, are arranged symmetrically in this case in relation to the central axis A of said stream F, at an equal distance from said axis.

As can also be seen in FIG. 8, said two central shafts 10, 20 are rotatingly driven in opposite directions with respect to one another in order to increase the speed of the stream in an overlap zone Z of the trajectories T1 and T2 which is situated between said two shafts.

FIG. 8 shows that by following the direction of the stream (in this case from the bottom to the top of the page) and considering that said stream is seen from above, one shaft, the shaft 10, is situated on the left and that the other shaft, the shaft 20, is situated on the right, therefore the left-hand shaft 10 is rotatingly driven in the anticlockwise direction in relation to its axis A10 and the right-hand shaft 20 is driven in the clockwise direction in relation to its axis A20.

The shaft 30 which is situated on the same lateral side of the device as the shaft 10 is rotatingly driven in the same direction as the shaft 10 and the shaft 40, which is situated on the same lateral side of the device as the shaft 20 is rotatingly driven in the same direction as the shaft 20.

It has been tested that when the four shafts are rotatingly driven at the same speed, a homogeneous stream is obtained downstream of the stirrer 1.

In said figure the lateral trajectories T3 and T4 are of the same diameter as the central trajectories 10, 20, but they can be smaller or larger.

In said configuration shown, there are additionally two trajectory overlap zones Z′ with opposite stirring: at the intersection, on the one hand, of the trajectory T3 with the trajectory T1 and, on the other hand, of the trajectory T2 with the trajectory T4. In each of said two zones, as the two adjacent shafts (30/120 and 20/40 respectively) are both driven in the same direction of rotation, the effect is not to increase the speed of the stream in said trajectory overlap zones Z′ with opposite stirring.

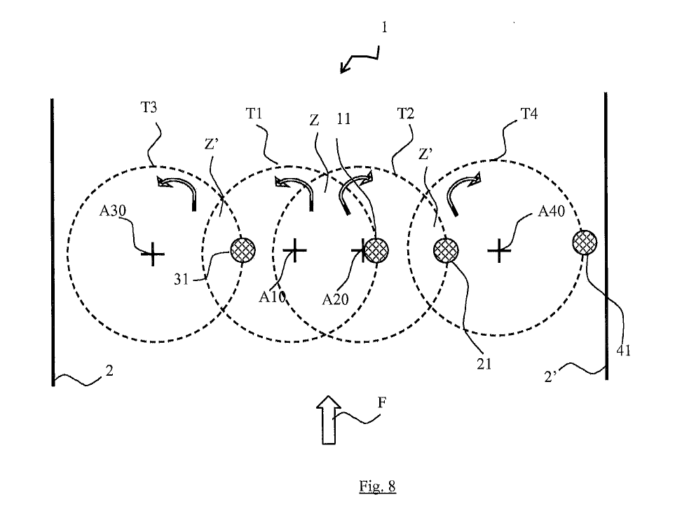

FIG. 9 shows an arrangement according to the invention, the axes of rotation of the stirrers being aligned in a direction perpendicular to the flow, a continuous source of coloring heterogeneity having been introduced at the point 90. It is observed that the coloring, after its passage in said device, is distributed uniformly in the entire width of the flow. The result is therefore very homogeneous mixing. The same efficiency can be noted whatever the position of the coloring source upstream of the stirrers.

FIG. 10 shows an arrangement according to the prior art, according to which two stirring rods have their axes aligned parallel to the direction of flow. It is noted that a coloring source placed in position 100 is not distributed in a homogeneous manner after passing through the mixing zone. The mixing obtained is much less homogeneous than in the case of FIG. 9.

Table 1 below gives the vertical and horizontal mean draw rates according to different configurations of stirring. Case 1 (reference) is that of FIG. 5 including the description which relates to it, the rods having a diameter of 40 mm over their entire height. Case 4 corresponds to the device shown in FIG. 6 which exerts a notable vertical component. The mixing effect is certainly tri-dimensional since the ratio between horizontal and vertical draws is 8, compared to a ratio of between 71 and 156 for examples according to the invention. Above all, the examples according to the invention provide draw rates in the horizontal plane at least 8 times in excess of those that are in case no. 4. Moreover, the tri-dimensional draw rate in case no. 4 is the square root of 26²+3.3², that is to say 26.2. This remains at least 8 times less than the draw rate of the examples according to the invention.

TABLE 1

| | Horizontal | Vertical | Ratio of horizontal |
|---|---|---|---|
| Case | draw rate | draw rate | to vertical draw rate |
| Case 1 - reference | 219 | 1.4 | 156 |
| Case 2 - idem case | 235 | 2.0 | 117 |
| 1, but diameter of | | | |
| rods = 20 mm | | | |
| Case 3 - idem case | 247 | 3.5 | 71 |
| 1, but diameter of | | | |
| rods = 80 mm | | | |
| Case 4 - Screw (cf. | 26 | 3.3 | 8 |
| FIG. 6) | | | |

The present invention is described in what precedes by way of example. It is understood that the expert is in a position to realize different variants of the invention without necessarily departing from the framework of the patent such as defined by the claims.

1. A method for producing a glass comprising forming a stream of molten glass which flows along a central axis and mixing said stream,
wherein said mixing is carried out by rotatingly driving n shafts, n being a whole number equal to or in excess of two, each having an axis positioned at an angle of between 0° and 30° inclusive in relation to a vertical in the direction of the central axis of said stream, two adjacent shafts being separated by a distance with their axes parallel and with each of said two adjacent shafts connected to at least one rod which is situated at least in part in said stream and each of said rods having an axis which is parallel to the axis of the shaft to which it is connected,
wherein for said two adjacent axes at least, the distance between the axis of one rod and the axis of the shaft to which it is connected is in excess of or equal to 9/20 of the distance between the axes of said two shafts so as to form an overlap zone which is situated between said two shafts, and wherein said two adjacent shafts are rotatingly driven in opposite directions with respect to one another with, following the direction of the stream and considering, when seen from above, that one of said two adjacent shafts is on the left and the other is on the right, the left-hand shaft being driven in the anticlockwise direction and the right-hand shaft being driven in the clockwise direction.

2. The method according to claim 1, wherein the mixing of the stream is carried out in horizontal planes, the mean draw rate in the horizontal plane being at least 10 times in excess of the mean vertical draw rate.

3. The method according to claim 2, wherein the mixing of the stream is carried out solely within horizontal planes which do not mix together.

4. The method according to claim 1, wherein, for said two adjacent shafts, one of said shafts is connected to at least one rod which is situated at least in part in said stream and the other shaft is connected at least to two rods which are each situated at least in part in said stream.

5. The method according to claim 1, wherein four adjacent shafts are rotatingly driven and each of said shafts is connected to a single rod, two adjacent shafts being rotatingly driven in opposite directions with respect to one another, following the direction of the stream and considering, when seen from above, that one of said two adjacent shafts is on the left and that the other one is on the right, the left-hand shaft is driven in the anticlockwise direction and the right-hand shaft is driven in the clockwise direction.

6. The method according to claim 1, wherein the axes of said two adjacent shafts are situated in a plane which is perpendicular to the direction of the central axis of the stream.

7. The method according to claim 6, wherein said two adjacent shafts are rotatingly driven at a same speed during the mixing with a dephasing which is
either 0° with two shafts which each include one single rod,
or 180°/x in relation to the adjacent shaft, x being the number of rods of the shaft to which the largest number of rods is connected and x≧2.

8. The method according to claim 1, wherein a speed of rotation of the shafts is between 1 and 20 revolutions per minute inclusive of said values for a speed of the stream upstream of the mixing of between 0.1 and 5.0 mm/s inclusive of said values.

9. The method according to claim 1, wherein said two adjacent shafts which are rotatingly driven in opposite directions with respect to one another are arranged at an equal distance from the central longitudinal axis of the stream.

10. The method according to claim 1, wherein said stream has a draw number nb which is at least equal to 20, said draw number nb being=L/(UT), with:
L which is a length along the axis along which the mixing is carried out, in mm,
U which is the mean speed of the fluid along said length, in mm/s, and
T which is the period of rotation of said shafts and which is worth 60/V where V is the speed of rotation of said shafts in revolutions/minute.

11. The method according to claim 1, wherein the distance between the rods and the shaft to which said rods are connected is identical during the mixing.

12. The method according to claim 1, wherein at least one shaft dip(s) into said stream, said shaft or shafts which dips or dip into said stream has or have in the part thereof which dips into said stream a form which is asymmetric in relation to the axis of the shaft.

13. A device for producing a glass according to claim 1, said device comprising a furnace which generates a stream of molten glass and a stirrer to mix said stream, wherein said device comprises n shafts which are rotatingly driven, n being a whole number equal to or in excess of two, each having an axis positioned at an angle of between 0° and 30° inclusive in relation to a vertical in the direction of the central axis of said stream, two adjacent shafts being separated by a distance with their axes parallel and with each of said two adjacent shafts connected to at least one rod which is situated at least in part in said stream and each of said rods having an axis which is parallel to the axis of the shaft to which it is connected,
wherein for said two adjacent axes at least, the distance between the axis of one rod and the axis of the shaft to which it is connected is in excess of or equal to 9/20 of the distance between the axes of said two shafts, and
wherein said two adjacent shafts are rotatingly driven in opposite directions with respect to one another with, following the direction of the stream and considering, when seen from above, that one of said two adjacent shafts is on the left and the other is on the right, the left-hand shaft being driven in the anticlockwise direction and the right-hand shaft being driven in the clockwise direction.

14. The device as claimed in claim 13, wherein the mixing of the stream is carried out in horizontal planes, the mean draw rate in the horizontal plane being at least 10 times in excess of the mean vertical draw rate.

15. The device as claimed in claim 14, wherein the mixing of the stream is realized carried out within horizontal planes which do not mix together.

16. The device as claimed in claim 13, wherein for said two adjacent shafts, one of said shafts is connected to at least one rod which is situated at least in part in said stream and the other shaft is connected at least to two rods which are each situated at least in part in said stream.

17. The device as claimed in claim 13, wherein four adjacent shafts are rotatingly driven and each of said shafts is connected to a single rod, two adjacent shafts being rotatingly driven in opposite directions with respect to one another, following the direction of the stream and considering, when seen from above, that one of said two adjacent shafts is on the left and that the other one is on the right, the left-hand shaft is driven in the anticlockwise direction and the right-hand shaft is driven in the clockwise direction.

18. The device as claimed in claim 13, wherein at least one rod has a smooth surface.

19. The device as claimed in claim 13, wherein at least one rod has a circular section which is identical all along the rod, with a diameter of between 20 and 150 mm inclusive.

20. The method according to claim 1, wherein the distance between the axis of one rod and the axis of the shaft to which it is connected is in excess of or equal to half the distance between the axes of the two shafts.

21. The method according to claim 2, wherein the mean draw rate in the horizontal plane is at least 30 times in excess of the mean vertical draw rate.

22. The method according to claim 21, wherein the mean draw rate in the horizontal plane is at least 50 times in excess of the mean vertical draw rate.

23. The method according to claim 6, wherein the axes of said two adjacent shafts are arranged symmetrically with respect to the central axis of said stream.

24. The method according to claim 12, wherein all the shafts dip into said stream.

25. The device according to claim 13, wherein the distance between the axis of one rod and the axis of the shaft to which it is connected is in excess of or equal to half the distance between the axes of the two shafts.

26. The device according to claim 14, wherein the mean draw rate in the horizontal plane is at least 30 times in excess of the mean vertical draw rate.

27. The device according to claim 26, wherein the mean draw rate in the horizontal plane is at least 50 times in excess of the mean vertical draw rate.

28. The device according to claim 18, wherein each rod has a smooth surface.

29. The device according to claim 19, wherein each rod has a circular section which is identical all along the rod.

30. The device according to claim 19, wherein the diameter is between 40 and 100 mm inclusive.
